(19) United States
(12) Patent Application Publication
(10) Pub. No.: US 2002/0129121 A1
(43) Pub. Date: Sep. 12, 2002

(54) Method and system for providing purchase referrals using machine-readable codes

(75) Inventors: William L. Reber, Rolling Meadows, IL (US); Cary D. Perttunen, Shelby Township, MI (US)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/801,236

(22) Filed: Mar. 7, 2001

(51) Int. Cl. G06F 15/16

(52) U.S. Cl. 709/219; 709/217

(57) ABSTRACT

An associate (12) of a referral program publishes a printed document (32) having a bar code (36) which identifies a computer network destination (42) at which an item is offered for sale. The bar code (36) further identifies the associate (12). The associate (12) receives compensation for a sale of the item made via the computer network destination (42) using the bar code (36).

### TECHNICAL FIELD

The present invention relates to purchase referral methods and systems.

### BACKGROUND OF THE INVENTION

Recent developments in Internet technology teach embedding, in print media, bar codes that encode specific Internet destinations. The bar codes facilitate access to Internet content using Web devices such as personal computers and cellular telephones having integrated bar code readers. U.S. Pat. Nos. 5,930,767, 5,938,726, 5,940,595, 5,969,324, 5,986,651, 5,995,105, 6,032,195, 6,081,827 and 6,138,151, which are assigned to Motorola, Inc. and are hereby incorporated by reference into the present disclosure, disclose various approaches to computer network navigation using bar codes.

Adoption of this approach may be advanced by proliferating bar codes in existing printed publications such as magazines, newspapers and catalogs. However, the decision whether or not to include bar codes in existing printed publications is currently made by the publication owners. A low adoption rate of publication owners may hinder the rate of growth of embedded bar codes for Internet access.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is a flow chart of an embodiment of a method of providing purchase referrals using machine-readable codes; and

FIG. 2 is a block diagram of an embodiment of a system for providing purchase referrals using machine-readable codes.

### DETAILED DESCRIPTION OF PREFERRED EMBODIMENTS

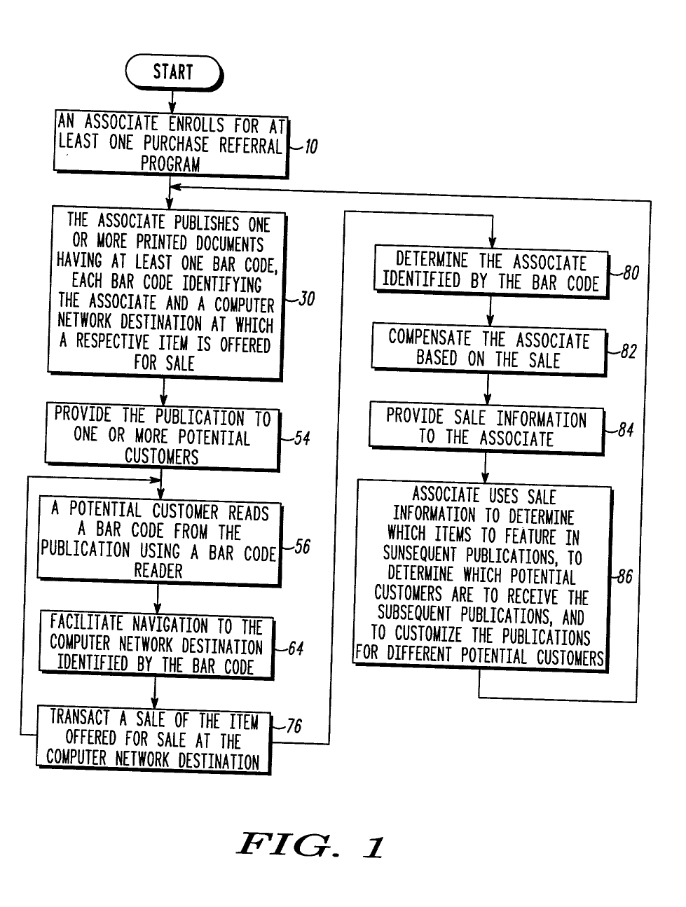

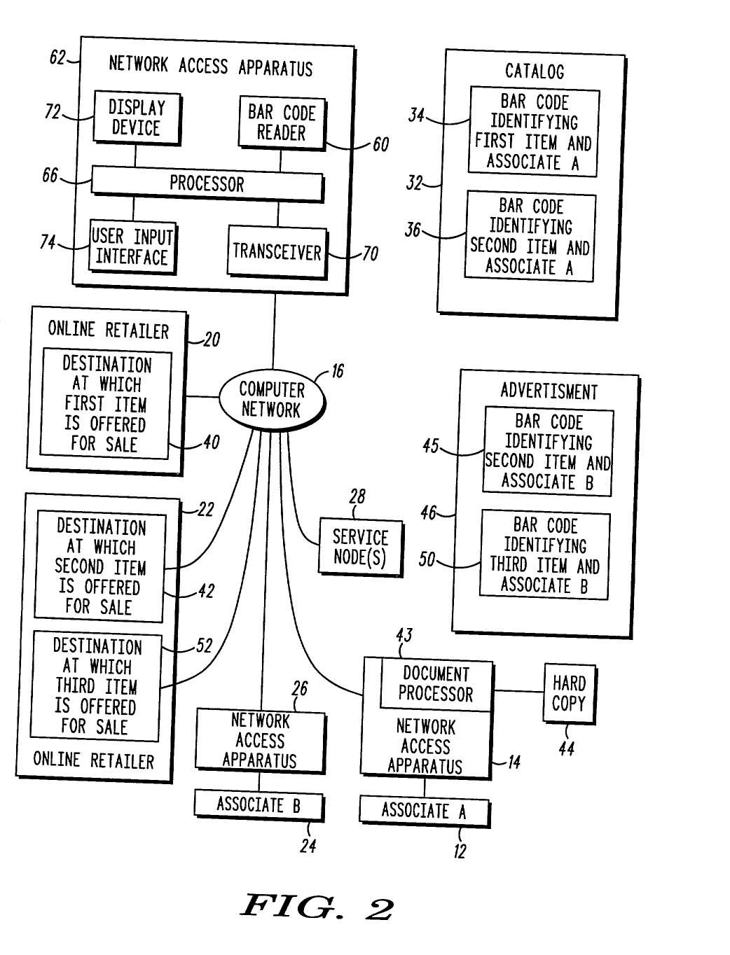

Disclosed herein are embodiments of methods and systems for providing purchase referrals using machine-readable codes. Each machine-readable code identifies a computer network destination at which an item is offered for sale and an associate who is to be compensated for a sale of the item made via the computer network destination. The prospect for compensation incentivizes individuals to become associates who publish printed documents having machine-readable codes for computer network navigation. Embodiments are described with reference to FIG. 1, which shows a flow chart of an embodiment of a method of providing purchase referrals using machine-readable codes, and FIG. 2, which shows a block diagram of an embodiment of a system for providing purchase referrals using machine-readable codes.

As indicated by block 10, the method comprises enrolling an associate 12 for at least one purchase referral program. An example of an Internet-based customer referral program is disclosed in U.S. Pat. No. 6,029,141 to Bezos et al., which is hereby incorporated by reference into the present disclosure. Preferably, the associate 12 uses a network access apparatus 14 to enroll in at least one referral program via a computer network 16. The network access apparatus 14 may have various implementations. Examples of the network access apparatus 14 include, but are not limited to, a computer, a personal digital assistant, a set-top box, a Web telephone, a two-way pager, a game player and various wireless network access apparatus. Examples of the computer network 16 include, but are not limited to, an internet, an intranet and an extranet.

Using the network access apparatus 14, the associate 12 submits enrollment information and receives an associate identifier. For example, consider the associate 12 enrolling in a purchase referral program provided by an online retailer 20. The online retailer 20 receives the enrollment information and provides the associate 12 a unique associate identifier via the computer network 16. The associate 12 may enroll in multiple purchase referral programs. For example, consider the associate 12 also enrolling in a purchase referral program provided by an online retailer 22 which differs from the online retailer 20. The online retailer 22 receives the enrollment information and provides the associate 12 a unique associate identifier via the computer network 16.

Multiple associates may enroll in a purchase referral program. For example, consider another associate 24 who uses a network access apparatus 26 to enroll in the purchase referral program provided by the online retailer 22. Examples of the network access apparatus 26 include those described with reference to the network access apparatus 14. Enrollment information for the associate 24 is submitted using the network access apparatus 26 and communicated via the computer network 16 to the online retailer 22. The online retailer 22 receives the enrollment information and provides the associate 24 a unique associate identifier via the computer network 16. In general, the associates 12 and 24 may be individuals, companies, or other entities.

Optionally, in contrast to the associates 12 and 24 interacting directly with the online retailers 20 and 22, a service node 28 may serve as an intermediary. In this case, the service node 28 interacts with the online retailers 20 and 22 to establish purchase referral programs. The associates 12 and 24 interact with the service node 28 to enroll for one or more purchase referral programs. For each associate, the service node 28 may aggregate a plurality of purchase referral programs under a universal associate identifier. In this case, the service node 28 may be capable of translating the universal associate identifier to an online-retailer-specific associate identifier. The service node 28 may be provided by a computer server system in communication with the computer network 16.

As indicated by block 30, an associate publishes one or more printed documents having at least one bar code. Each bar code identifies the associate and a computer network destination at which an item is offered for sale. Each bar code encodes information, in accordance with either a one-dimensional bar code symbology or a two-dimensional bar code symbology, either to directly or indirectly identify the associate and the computer network destination. To directly identify the associate, the bar code may encode the associate identifier. To directly identify the computer network destination, the bar code may encode a computer address of the computer network destination. Examples of the computer address include, but are not limited to, a Uniform Resource Locator (URL), a Uniform Resource Name (URN), a Uniform Resource Identifier (URI) and an Internet Protocol (IP) address. To indirectly identify the associate and the computer network destination, the bar code may encode information translatable by the service node 28.

Typically, the printed document comprises one or more sheets of a print medium which supports the bar codes. For purposes of illustration and example, consider the associate 12 publishing a catalog 32 having a bar code 34 which identifies a first item offered for sale by the online retailer 20, and a bar code 36 which identifies a second item offered for sale by the online retailer 22. The bar code 34 either directly or indirectly encodes a computer address of a computer network destination 40 at which the first item is offered for sale. The bar code 36 either directly or indirectly encodes a computer address of a computer network destination 42 at which the second item is offered for sale.

Each of the bar codes 34 and 36 identifies the associate 12. The bar code 34 may either directly or indirectly encode the associate identifier provided to the associate 12 by the online retailer 20. The bar code 36 may either directly or indirectly encode the associate identifier provided to the associate 12 by the online retailer 22.

The network access apparatus 14 may comprise a document processor 43 to publish printed documents having bar codes which identify the associate and computer network destinations at which items are offered for sale. The document processor 43 may be enabled by software installed in the network access apparatus 14. The document processor 43 may direct a hard copy device 44, such as a laser printer or an ink jet printer, to print the publications. Optionally, a kit comprising the document processing software (e.g. computer-readable content of a computer-readable medium) and paper on which to print the publications may be sold at retail stores to encourage individuals to become associates.

In another example, consider the associate 24 publishing an advertisement 45 in a magazine. The advertisement 45 includes a bar code 46 which identifies the second item offered for sale by the online retailer 22, and a bar code 50 which identifies a third item offered for sale by the online retailer 22. The bar code 46 either directly or indirectly encodes a computer address of the computer network destination 42 at which the second item is offered for sale. The bar code 50 either directly or indirectly encodes a computer address of a computer network destination 52 at which the third item is offered for sale. Each of the bar codes 46 and 50 identifies the associate 24. The bar codes 46 and 50 may either directly or indirectly encode the associate identifier provided to the associate 24 by the online retailer 22.

For the purposes of this patent application, the term “publishing” is meant to broadly include either printing the document, causing the document to be printed, or causing the document to include the herein-disclosed bar codes. Thus, examples of an associate publishing the herein-disclosed bar codes include, but are not limited to: printing a catalog or the like having one or more of the herein-disclosed bar codes; and submitting an advertisement having one or more bar codes to a newspaper, a magazine, or another periodical.

As indicated by block 54, the method comprises providing publications to one or more potential customers. A publication may be provided to a potential customer via direct mailing, via hand delivery, at a retail store such as a bookstore or a newsstand, as an insert in a periodical such as a magazine or a newspaper, as an advertisement in a periodical such as a magazine or a newspaper, or in an alternative manner.

As indicated by block 56, the method comprises a potential customer reading a bar code from a publication using a bar code reader 60 associated with a network access apparatus 62. Examples of the network access apparatus 62 include those described with reference to the network access apparatus 14. The bar code reader 60 may be either integrated with, attached to, or otherwise in communication with the network access apparatus 62. Of particular interest is the network access apparatus 62 comprising a Web-enabled, wireless handheld device, such as a Web-enabled cellular telephone, having an integrated bar code reader. Also of interest is the bar code reader 60 being integrated with, attached to, or otherwise in communication with a remote control for an internet television or an internet set-top box.

As indicated by block 64, navigation to a computer network destination identified by the bar code is facilitated. If the bar code directly encodes a computer address of the computer network destination and an associate identifier, a processor 66 decodes the read bar code data to extract same. If the bar code indirectly encodes the computer address and the associate identifier, a transceiver 70 responsive to the processor 66 may send one or more messages via the computer network 16 to the service node 28, which in turn translates the read bar code data to a computer address and an associate identifier.

The processor 66 may comprise one or more microprocessors, one or more microcontrollers, or other implementations of a logic circuit. The processor 66 either directs or assists in directing acts performed by various components of the network access apparatus 62. The processor 66 may be directed by computer-readable content of a computer-readable medium. Examples of the computer-readable medium include a computer-readable storage medium and a computer-readable communication medium. Examples of computer-readable storage media include, but are not limited to, an electronic medium such as a computer memory, a magnetic medium such as a floppy disk or a hard disk, and an optical medium such as an optical disk. Examples of computer-readable communication media include, but are not limited to, an electronic medium, an optical medium and an electromagnetic medium. Examples of the transceiver 70 include, but are not limited to, a wireless radio frequency transceiver, a wireless modem, a dial-up modem, a cable modem and a network interface card.

Regardless of how the computer address is determined, the transceiver 70 is responsive to the processor 66 to facilitate navigation via the computer network 16 to the computer address. For example, the transceiver 70 may send one or more messages to attempt to link to a server at the computer network destination, and to request a computer network resource.

Preferably, the transceiver 70 sends a request message which contains a first identifier of the item and a second identifier of the associate, wherein the first identifier and the second identifier are encoded by the bar code. The server at the computer network destination receives the request message and generates the requested computer network resource in the form of one or more response messages.

The transceiver 70 receives the requested computer network resource from the server. Received media content may be processed by the processor 66 based on markup data. The processor 66 provides a display signal to a display device 72 to display the marked-up content. Examples of the display device 72 include, but are not limited to, a liquid crystal display, a cathode ray tube, a field emission display, a computer monitor, a television, and a display on a wireless communication device such as a wireless telephone.

The requested computer network resource may be a Web page, for example, having visible content and/or audible content which provides information about the item identified by the bar code. Such information includes, but is not limited to, a picture of the item, textual or audible information describing the item, a price of the item, reviews of the item, an availability of the item, and shipping information.

The potential customer may navigate within or otherwise interact with the computer network destination using a user input interface 74. The potential customer may interact with the computer network destination to gather information about the item, and/or to place an order for the item. The user input interface 74 senses one or more user-initiated actions, and generates signals based thereon. Examples of the user input interface 74 include, but are not limited to, any combination of a touch-sensitive screen of the display device 72, a mouse, a trackball, a pointing stick, a touch pad, a joystick, a keyboard, a voice input device, and a pen input device.

For purposes of illustration and example, consider the potential customer seeing an item in the catalog 32 which he/she wishes to purchase. Using the bar code reader 60, the potential customer reads the bar code 36 corresponding to the item. Navigation is facilitated to the computer network destination 42 at which the item is offered for sale. Item information is received from the computer network destination 42, and displayed by the display device 72. Using the user input interface 74, the potential customer generates an input which finalizes his/her purchase of the item.

As indicated by block 76, the method comprises transacting a sale of the item offered for sale at the computer network destination. Continuing with the above example, the online retailer 22 would transact the sale of the item offered for sale at the computer network destination 42 to the customer.

Acts indicated by blocks 56, 64 and 76 may be repeated by the customer. The customer may use the bar code reader 60 to read another bar code, either from the same publication or from a different publication, to initiate another purchase.

As indicated by block 80, the method comprises determining the associate identified by the bar code. The associate may be determined based upon an associate identifier directly encoded within the bar code, and included as part of the computer address of the computer network destination. Alternatively, the associate may be determined based upon an associate identifier provided by the service node 28. Continuing with the above example, either the online retailer 22 or the service node 28 would determine that the bar code 36 identifies the associate 12.

As indicated by block 82, the method comprises compensating the associate based on the sale. The associate may be compensated by crediting an account associated with the associate. Continuing with the above example, either the online retailer 22 or the service node 28 would compensate the associate 12 for the sale of the item.

As indicated by block 84, the method comprises providing sale information to the associate. The sale information indicates which item has been sold, and optionally, to whom the item was sold. Preferably, the sale information is provided via the computer network 16 from an online retailer to a network access apparatus associated with the associate. Continuing with the above example, either the online retailer 22 or the service node 28 would provide the sale information via the computer network 16 to the network access apparatus 14 associated with the associate 12.

As indicated by block 86, the associate may use the sale information to make decisions for subsequent publications. The sale information may be used to determine which items should be featured in subsequent publications, to determine which potential customers are to receive the subsequent publications, and to customize the publications for different potential customers. Decisions for subsequent publications may also be based upon personal preference information received from potential customers. Potential customers may indicate their personal preferences using bar codes on a printed document such as those described with reference to block 30. Personal preference information promotes customization of the publications for different potential customers.

Acts performed by the network access apparatus 14 and 26, the online retailers 20 and 22, and the service node 28 may be directed by respective computer-readable content of a respective computer-readable medium. Examples of the computer-readable medium include a computer-readable storage medium and a computer-readable communication medium. Examples of computer-readable storage media include, but are not limited to, a computer memory, a magnetic floppy disk, a magnetic hard disk, and an optical disk. Examples of computer-readable communication media include, but are not limited to, an electronic medium, an optical medium and an electromagnetic medium. Each server system which provides the service node 28 and the online retailers 20 and 22 may comprise either a single server computer or a plurality of computers.

Thus, there have been described herein several embodiments including a preferred embodiment of a method and system for providing purchase referrals using machine-readable codes.

It will be apparent to those skilled in the art that the disclosed invention may be modified in numerous ways and may assume many embodiments other than the preferred form specifically set out and described above. For example, some of the acts described with reference to FIG. 1 may be performed either concurrently or in an alternative order. In particular, any of acts indicated by blocks 80, 82, 84 and 86 for a first sale may be performed concurrently with any of acts indicated by blocks 56, 64 and 76 for a second sale. Further, any of the acts indicated by blocks 80, 82, 84 and 86 may be initiated based on time (e.g. at periodic intervals such as either weekly, monthly or quarterly), based on a number of referrals (e.g. once a specific number of referrals has been attained), based on a sales figure (e.g. once a specific sales amount has been attained), or based on a request from an associate (e.g. via the computer network 16).

Further, alternative machine-readable codes which identify a computer network destination and an associate may be substituted for the herein-disclosed bar codes. Examples of alternative machine-readable codes include, but are not limited to, alternative optical codes, codes from radio frequency tags, magnetic codes, and electronic codes. Regardless of their form, the machine-readable codes are readable by a manual machine-readable code reader, i.e. a reader handled by the potential customer to read the code. These codes contrast codes which are non-manually read, for example those readable by a floppy disk drive, a hard disk drive, a CD reader or a DVD reader. Other examples of alternative machine-readable codes include audio codes from a broadcast and audio codes from a pre-recorded medium.

Still further, alternative objects may be used to support the herein-disclosed bar codes or alternative machine-readable codes. In particular, objects other than sheets of print media are contemplated to support machine-readable codes for purchase referrals.

Yet still further, embodiments of the present invention may be adapted to compensate associates for non-purchase referrals to computer network destinations. An example of a non-purchase referral is one in which a potential customer reads a bar code to navigate to a computer network destination at which an item is offered for sale, but makes no purchase of the item via the computer network destination. In these alternative embodiments, block 82 in FIG. 1 may be modified to compensate an associate at a first value or rate for a purchase referral, and at a lower value or rate for a non-purchase referral. Block 84 may be modified to provide non-purchase referral information to the associate in addition to any sale information. Block 86 may be modified such that the associate also uses non-purchase referral information to determine which items to feature in subsequent publications, to determine which potential customers are to receive subsequent publications, and to customize the publications for different potential customers.

Accordingly, it is intended by the appended claims to cover all modifications of the invention which fall within the true spirit and scope of the invention.

What is claimed is:

1. An article comprising:
an object; and
a first bar code supported by the object, the first bar code identifying a first computer network destination at which a first item is offered for sale, the first bar code further identifying an associate who is to be compensated for a sale of the first item made via the first computer network destination using the first bar code.

2. The article of claim 1 further comprising:
a second bar code supported by the object, the second bar code identifying a second computer network destination at which a second item is offered for sale, the second bar code further identifying the associate who is to be compensated for a sale of the second item made via the second computer network destination using the second bar code.

3. The article of claim 2 wherein the first computer network destination is associated with a first online retailer, and the second computer network destination is associated with a second online retailer which differs from the first online retailer.

4. The article of claim 1 wherein the object comprises a sheet of a print medium which supports the first bar code.

5. A method comprising:
publishing a printed document having a first bar code which identifies a first computer network destination at which a first item is offered for sale, the first bar code further identifying an associate of a referral program; and
receiving, by the associate, compensation for a sale of the first item made via the first computer network destination using the first bar code.

6. The method of claim 5 wherein the printed document has a second bar code which identifies a second computer network destination at which a second item is offered for sale, the second bar code further identifying the associate of the referral program.

7. The method of claim 6 further comprising receiving, by the associate, compensation for a sale of the second item made via the second computer network destination using the second bar code.

8. The method of claim 7 wherein the first computer network destination is associated with a first online retailer, and the second computer network destination is associated with a second online retailer which differs from the first online retailer.

9. An apparatus comprising:
a document processor to publish a printed document having a first bar code which identifies a first computer network destination at which a first item is offered for sale, the first bar code further identifying an associate of a referral program.

10. The apparatus of claim 9 wherein the document processor is to publish the printed document with a second bar code which identifies a second computer network destination at which a second item is offered for sale, the second bar code further identifying the associate of the referral program.

11. The apparatus of claim 10 wherein the first computer network destination is associated with a first online retailer, and the second computer network destination is associated with a second online retailer which differs from the first online retailer.

12. A computer-readable medium having computer-readable content to direct a processor to publish a printed document having a first bar code which identifies a first computer network destination at which a first item is offered for sale, the first bar code further identifying an associate of a referral program.

13. The computer-readable medium of claim 12 wherein the computer-readable content further directs the processor to publish the printed document with a second bar code which identifies a second computer network destination at which a second item is offered for sale, the second bar code further identifying the associate of the referral program.

14. The computer-readable medium of claim 13 wherein the first computer network destination is associated with a first online retailer, and the second computer network destination is associated with a second online retailer which differs from the first online retailer.

15. A kit comprising:
a print medium; and
a computer-readable medium having computer-readable content to direct a printer to print onto the print medium a first bar code which identifies a first computer network destination at which a first item is offered for sale, the first bar code further identifying an associate of a referral program.

16. The kit of claim 15 the computer-readable content further directs the printer to print onto the print medium a second bar code which identifies a second computer network destination at which a second item is offered for sale, the second bar code further identifying the associate of the referral program.

17. A method comprising:
transacting a sale of an item made via a computer network destination using a bar code, the bar code identifying the computer network destination at which the item is offered for sale, the bar code further identifying an associate of a referral program; and
compensating the associate based on the sale.

18. The method of claim 17 further comprising:
receiving a request message which contains a first identifier of the item and a second identifier of the associate, wherein the first identifier and the second identifier are encoded by the bar code;
wherein said transacting the sale is based on the request message.

19. A system comprising:
a server system at a computer network destination identified by a bar code which further identifies an associate of a referral program, the server system to offer an item for sale via the computer network, to transact a sale of the item via the computer network, and to compensate the associate based on the sale.

20. The system of claim 19 wherein the server system is to receive a request message which contains a first identifier of the item and a second identifier of the associate, wherein the first identifier and the second identifier are encoded by the bar code, and wherein the server system is to transact the sale based on the request message.
